(19) United States
(12) Patent Application Publication
(10) Pub. No.: US 2003/0129025 A1
(43) Pub. Date: Jul. 10, 2003

(54) Method and apparatus for fixedly attaching tiled armor panels

(76) Inventor: John Donovan, Danvers, IL (US)

Correspondence Address: Michael A. DeSanctis, FAEGRE & BENSON LLP, 2500 Republic Plaza, 370 Seventeenth Street, Denver, CO, 80202, US

(21) Appl. No.: 09/683,494

(22) Filed: Jan. 8, 2002

(51) Int. Cl. B23K 9/09; B23K 9/23; B23K 9/235

(52) U.S. Cl. 403/400; 228/135

(57) ABSTRACT

A method and apparatus for fixedly attaching modular tiles. The present invention uses a combination of a surface to be covered, a modular tile, a mounting plate, a peg and a wedge. Alternately, the present invention can also be used without the mounting plate. The present invention first securely fastens the peg to the surface to be covered. Next, the modular tile, with an aperture matching the peg, is placed over the peg and is seated flush against the surface. Next, the mounting plate, with an aperture matching the peg, is placed over the peg and is seated flush against the modular tile. A wedge is then securely placed into an aperture located on the peg, thus compressing the underlying components and securely locking them in place.

### BACKGROUND OF INVENTION

The present invention relates generally to a method and apparatus for applying and fixedly attaching tile panels to walls, ceiling, floors, and the like. More specifically, the present invention relates to a method and apparatus to fixedly attach tiled armor plates to the interior surfaces of an explosion containment and suppression chamber.

As discussed in my U.S. patent application Ser. No. 09/683,492 filed on Jan. 8, 2002, there is a need in the explosion containment and suppression chamber field to effectively and efficiently protect the interior surfaces of an explosion chamber. Since the interior surfaces of an explosion chamber are repeatedly bombarded by shrapnel, instantaneous pressure increases and extreme temperature variations, the interior surfaces must be adequately protected; otherwise constant maintenance and surface replacement will be required. This type of maintenance is not only very expensive and time consuming, but the entire explosion chamber system must be temporarily decommissioned until the interior surfaces are repaired.

As disclosed in my U.S. patent application Ser. No. 09/683,492 filed on Jan. 8, 2002, I have previously invented a new and useful improvement of protecting the interior surfaces of an explosion suppression chamber by lining the interior surfaces with armored tile plates. The armored tile plates, being of modular design, absorb the brunt of the explosion's pressures, temperatures and ejected shrapnel. As such, the interior skin of the explosion chamber remains protected and unharmed even after repeated explosions within the chamber. Furthermore, in the inevitable event that an armored tile plate requires maintenance or replacement, one or more individually damaged armored tiles can be quickly and easily replaced, thus negating the need to repair or replace an entire wall, floor, ceiling or door. As such, the invention disclosed in my U.S. Ser. No. 09/683,492 provides an efficient and effective method of protecting the interior surfaces of an explosion suppression chamber.

However, as disclosed in U.S. Ser. No. 09/683,492 is that the armored tile plates are preferably fixedly attached to the interior skin of the explosion suppression chamber with conventional fillet welds. As such, when a modular plate requires replacement, the fillet weld must be cut prior to the armored tile's removal. Furthermore, due to the preferred armored tile plate material composition meeting AR-500 armor specifications and the interior surfaces of the explosion chamber preferably being constructed of a hardened steel, effective welding techniques are quite difficult to accomplish due to the differences in metal compositions.

Also, due to the modular design of the armored tile plates, the fillet welds along the joint between each adjacently placed armored tile plates is a weak point and is not as strong as the armored tile plates themselves. As such, the connecting fillet welds are more prone to deteriorate due to continuous explosions, subsequently weakening the attachment mechanism between the armored tile plates and the interior surfaces of the explosion chamber. Notwithstanding, the invention as disclosed in Ser. No. 09/683,492 is an effective and efficient method of protecting the interior surfaces of an explosion suppression and containment chamber.

The present invention improves upon attaching armored tile plates by, for example, utilizing an attachment system which facilitates the quick and easy removal and replacement of modular tiled armor plates; where welding is required, it is conducted between common metals, thus providing a contiguous and strengthened weld; and the seams and joints between adjacent armored tile plates are protected with armored material, thus enhancing the life and structural stability of the joint.

### SUMMARY OF INVENTION

It is therefore an object of the present invention to provide a method and apparatus to fixedly attach modular tiled armor plates to the interior surfaces of an explosion suppression and containment chamber.

It is another object of the present invention to provide a method and apparatus to fixedly attach modular tiled armor plates to the interior surfaces of an explosion suppression and containment chamber which also facilitates quick and easy installation and removal.

It is yet another object of the present invention to provide a method and apparatus of protecting seams between adjacently connected modular tiled armor plates.

It is still another object of the present invention to minimize the amount of required welding to facilitate the attachment of the armored tile plates.

Another object of the present invention is to maintain like metals where welding is required, thus greatly strengthening the welded intersections.

The present invention is best described as an improved method and apparatus to fixedly attach modular tiles to walls, ceilings, floor, and the like. The present invention is preferably used in explosion suppression and containment chambers, wherein the continuous explosive forces are dissipated much better by the present invention. However, it should be understood that the present invention can be utilized in any application where it is desired to fixedly attach panel or tiles to any surface in any environment.

The present invention uses a combination of a tile plate, preferably armored, a mounting plate, a peg and a preferably tapered wedge. The tile plate and the mounting plate both have an aperture of the same geometric configuration and size as the peg. Furthermore, the peg, being of any geometric configuration, such as cylindrical, rectangular, trapezoidal, and the like, has an aperture designed to readily receive the small end of the wedge. However, the peg aperture is smaller than the large end of the wedge. As such, the wedge can efficiently and easily be placed into the peg aperture, wherein the peg aperture is not large enough to permit the wedge to completely pass through the opening.

To use the present invention, the peg is first fixedly attached to the surface skin where the tile plates are desired to be attached. Next, the tile plate is placed on top of the peg whereby the tile plate aperture readily receives the peg. As such, when the tile plate is properly seated against the surface skin, the peg protrudes through the tile plate via the aperture. Next, the mounting plate is placed on top of the tile plate whereby properly aligning its aperture to receive the peg. As such, when the mounting plate is properly and completely seated against the tile plate, the peg will protrude through the mounting plate. The mounting plate, and underlying tile plate, are held in place by wedging the small side of the wedge into the peg aperture until the wedge is securely seated. As such, when the wedge is securely seated, the present invention provides an efficient method of fixedly attaching the tile plate to the surface skin while still facilitating quick and easy removal of the tile plate.

An alternate embodiment of the present invention further incorporates placing a securing means at the peg and wedge intersection to further ensure that the wedge attachment will be maintained. The securing means is preferably a tack weld, but it can alternately be a locking device such as a linchpin.

Another alternate embodiment of the present invention provides a protecting plate, which is preferably in a configuration of a “U” shape. The protecting plate is subsequently fixedly attached above the present invention attachment apparatus, substantially covering the attachment apparatus and protecting it from any damage.

Yet another alternate embodiment of the present invention protects any seams and joints between adjacently placed tile plates by providing a protective shield immediately above the joints.

### BRIEF DESCRIPTION OF DRAWINGS

The preferred and alternate embodiments will herein be described in detail with references to the following figures, where appropriate, wherein:

FIG. 1 is a schematic elevation view of the present invention while in an assembled and attached state;

FIG. 2 is cross-sectional view of the present invention while in an assembled and attached state depicting the preferred configuration and placement of the tapered wedge;

FIG. 3 is a simplified elevation view of the preferred embodiment's peg configuration depicting the preferably rectangular peg aperture designed to readily receive the small edge of the tapered wedge;

FIG. 4 is a simplified plan view of the preferred embodiment's wedge geometric configuration;

FIG. 5 is an elevation view of the mounting plate depicting the preferred embodiment's aperture location;

FIG. 6 is an elevation view of the present invention in an assembled and attached state securing a plurality of tile plates to the surface of a wall and the preferred embodiment's joint protection; and

FIG. 7 is a cross-sectional view of the present invention incorporating the use of the alternate embodiment's attachment device protection.

### DETAILED DESCRIPTION

The preferred embodiment of the present invention is best described as a method and apparatus for fixedly attaching tiles to any structure surface, such as a wall, ceiling, floor, and the like. The present invention is intended to be utilized in conjunction with attaching armored tile plates to the interior surfaces of an explosion containment and suppression chamber, such as is disclosed in my U.S. patent application Ser. No. 09/683,492. It is to be understood, of course, that the present invention can be utilized in any type of attachment application which may benefit from the present invention and is not to be limited to tiles, plates, armored tiles and explosion chambers. The present invention is intended to be broadly construed as being applicable to any application and within any environment where it is desirable to maintain an easy and quick method and apparatus to fixedly attach tiles, panels and the like to any type of surface. As such, the present invention's focus on attaching armor tile plates within an explosion suppression chamber is to be construed as an exemplification of the present invention's application rather than a limitation.

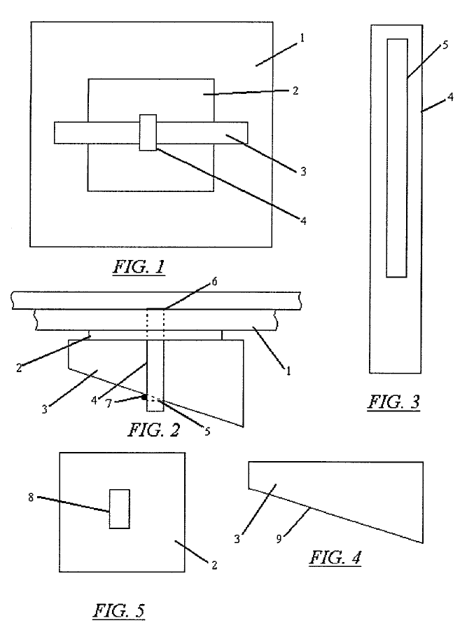

Referring to FIGS. 1 and 2, the preferred embodiment of the present invention comprises the combined use of a tile 1, which is desired to be fixedly mounted, a mounting plate 2, a peg 4, preferably with a consistent geometric configuration, and a tapered wedge 3. Alternately, the present invention can be used without the mounting plate. Referring to FIG. 4, the tapered wedge 3 is preferably trapezoidal with at least one tapered edge 9. Alternately, the tapered wedge 3 can be other configurations such as conical, tapered cylindrical, tapered rectangular and the like. The present invention, when in an assembled condition, shall hereinafter be collectively referred to as “attachment system” and depicted by figure elements 2,3,4.

Referring to FIG. 3, the peg 4 is preferably a consistent geometric configuration such as rectangular or cylindrical. Furthermore, the peg 4 preferably has a peg aperture 5 on at least on end having the same geometric configuration as and designed to readily receive the narrowest end of the tapered wedge 3. However, the peg aperture 5 is preferably designed to not be large enough to facilitate the complete passing through of the tapered wedge 3 through the peg aperture 5. As such, to achieve the preferred embodiment, the peg aperture 5 is larger than the smallest end of the tapered wedge 3 but the peg aperture 5 is smaller than the largest end of the tapered wedge 3.

Referring to FIG. 5, the mounting plate 2 has a mounting plate aperture 8 of the same geometric configuration and size as the peg 4. The mounting plate aperture 8 is preferably located in the center of the mounting plate 2. Furthermore, within the preferred embodiment of the present invention, the tile 1, which is desired to be mounted, also has a tile aperture of the same geometric configuration and size as the peg 4, preferably located in the center of the tile 1.

Referring again to FIGS. 1 and 2, the preferred embodiment of the present invention fixedly attaches the peg 4 with a peg attaching means at an attachment location 6 to the skin of the surface which is to be covered and protected by the tile 1. The preferred peg attaching means is welding the peg 4 to the surface skin at an attachment location 6. Alternately, other peg attaching means can be utilized, such as threading the attachment end of the peg 4 into a threaded aperture in the skin surface, adhesives, and the like. Further alternately, the surface to be covered can have an aperture to readily receive the peg 4, wherein the peg 4 can protrude through the surface and be attached via a peg attaching means on the back side of the surface.

The preferred embodiment next places the tile 1 over the peg 4, wherein the tile aperture readily receives the peg 4. The tile 1 is seated flush against the surface skin. The preferred embodiment of the present invention next places the mounting plate 2 over the peg 4, wherein the mounting plate aperture 8 receives the peg 4 and the mounting plate is seated flush against the tile 1. Alternately, the present invention can skip this step and not use the preferred mounting plate 2. Next, the preferred embodiment wedges the tapered wedge 3 through the peg aperture 5 until the tapered wedge 3 is securely seated within the peg aperture 5. Within the preferred embodiment, the tapered wedge 3 is seated flush against the surface of the mounting plate 2, wherein when the tapered wedge 3 is firmly seated, the tapered wedge 3 compresses the mounting plate 2 and tile 1 against the surface skin of the surface to be covered thus providing a more structurally sound attachment.

Upon assembly, an alternate embodiment of the present invention fixedly secures the tapered wedge 3 with a wedge securing means 7. The wedge securing means 7 is preferably a tack weld which is placed at the intersection of the peg aperture 5 and tapered wedge 3, designed to fixedly secure the tapered wedge 3 and prevent its inadvertent removal or loosening. Alternate securing means, such as threaded bolts, linchpins, and the like, can be utilized while achieving the same objective.

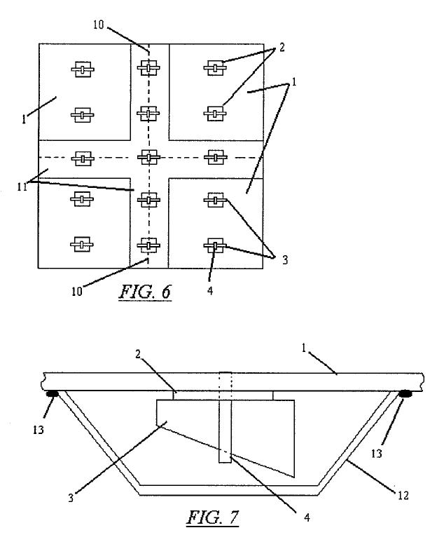

Now referring to FIG. 6, to apply a tile 1 to a surface, the preferred embodiment uses at least one attachment system 2,3,4 as described by the present invention. Preferably, a plurality of attachment systems 2,3,4 are utilized to enhance load distribution and to ensure redundancy in case of a non-noticeable structural failure of a single attachment system 2,3,4.

Yet another alternate embodiment of the present invention utilizes seam armor plates 11 to substantially cover and protect seams 10 created by adjacently placed tile 1. The seam armor plates 11 can be constructed of any length or width which is suitable under the circumstances.

Referring to FIG. 7, another alternate embodiment of the present invention includes a protective means for the attachment system 2,3,4. The alternate embodiment uses a shield design 12, in a modified “U” shaped configuration which substantially covers any attachment system 2,3,4. However, alternate geometric configurations of the shield design can be effectively utilized. The protective means is preferably made of the same material as the tile 1 discussed above. The shield design 12 is preferably fixedly attached to the tile 1 with an attaching means, preferably using conventional fillet welds 13. Alternately, other methods of attachment means can be utilized, such as threaded fasteners, rivets, cotter pins, adhesives or the like. The preferred fillet welds 13 are preferably appropriately angled in order to facilitate explosive impact pressure dissipation typically encountered during an explosion.

While preferred and alternate embodiments have been described herein, it is to be understood that these descriptions are only illustrative and are thus exemplifications of the present invention and shall not be construed as limiting. It is to be expected that others will contemplate differences, which, while different from the foregoing description, do not depart from the true spirit and scope of the present invention herein described and claimed.

1. A method of fixedly attaching modular tiles, said modular tiles creating a tile seam when said modular tiles are adjacently placed, the method comprising the steps of:
fixedly attaching the distal end of a peg to the surface to be tiled with a peg securing means, said peg having a consistent geometric cross-section and the proximate end of said peg having a geometric aperture, said geometric aperture having a width;
creating a modular tile aperture within said modular tile, said modular tile aperture being approximately the same size and geometric shape as said peg wherein said peg can readily fit therethrough;
placing said modular tile onto said peg wherein said modular tile aperture readily receives said peg and said module is seated flush against said surface;
preparing said modular tile for wedging; and
inserting a wedge into said geometric aperture thereby creating an attachment system, said wedge having a width no greater than said width of said geometric aperture

2. A method as claimed in claim 1 wherein the step of preparing said modular tile for wedging comprises the step of flushly seating a mounting plate on said modular tile by placing said mounting plate onto said peg, said mounting plate having a mounting plate aperture, said mounting plate aperture being approximately the same size and geometric shape as said peg wherein said peg can readily fit therethrough.

3. A method as claimed in claim 1 further comprising the step of securing said wedge with a wedge securing means.

4. A method as claimed in claim 1 wherein said peg securing means is a conventional weld.

5. A method as claimed in claim 1 wherein said peg securing means is a threaded peg retained by a threaded aperture in said surface.

6. A method as claimed in claim 1 wherein said wedge consists of a geometric shape with at least one tapered edge.

7. A method as claimed in claim 2 wherein said wedge securing means comprises the step of placing a tack weld at the intersection of said peg and said wedge.

8. A method as claimed in claim 2 wherein said wedge securing means is a bolt.

9. A method as claimed in claim 2 wherein said wedge securing means is a linchpin.

10. A method as claimed in claim 1 further comprising the step of protecting said attachment system with a protecting means.

11. A method as claimed in claim 10 wherein said protecting means comprises a shield plate.

12. A method as claimed in claim 11 wherein said shield plate is shaped in a “U” configuration.

13. A method of protecting tile seams between adjacently placed modular tiles comprising the step of attaching a tile seam protecting plate to said tile seams with a tile seam protecting plate attaching means, said tile seam protecting plate having a length and width to substantially cover said tile seam.

14. A method as claimed in claim 13 wherein said tile seam protecting plate attaching means comprises the method as claimed in claim 1.

15. An apparatus for fixedly attaching modular tiles, said modular tiles creating a seam when said modular tiles are adjacently placed, said apparatus comprising, in combination:
a peg, said peg having a distal end and a proximate end, said distal end attached to the surface to be tiled with a peg securing means, said peg further having a consistent geometric cross-section, said proximate end having a geometric aperture, said geometric aperture having a width;
a modular tile, said modular tile having a modular tile aperture, said modular tile aperture being approximately the same size and geometric shape as said peg wherein said peg can readily fit therethrough, said geometric aperture being accessible when said modular tile is placed onto s and seated flush against said surface; and
a wedge, said wedge having a width no greater than said width of said geometric aperture and having at least one tapered edge, said wedge being securely wedged into said geometric aperture, said wedge being secured with a wedge securing means.

16. An apparatus as claimed in claim 15 further comprising a mounting plate, said mounting plate seated flush against said modular tile, said mounting plate having a mounting plate aperture, said mounting plate aperture being approximately the same size and geometric shape as said peg wherein said peg can readily fit therethrough.

17. An apparatus as claimed in claim 15 wherein said peg securing means is a conventional weld.

18. An apparatus as claimed in claim 15 wherein said peg securing means comprises a threaded aperture in said surface and threads on said distal end of said peg, said threaded aperture having the same diameter and thread count as said threads on said distal end of said peg.

19. An apparatus as claimed in claim 15 wherein said wedge securing means is a conventional weld.

20. An apparatus as claimed in claim 15 wherein said wedge securing means is a bolt.

21. An apparatus as claimed in claim 15 further comprising a wedge and peg protecting means, said wedge and peg protecting means being placed over said wedge and said peg thereby substantially covering both said wedge and said peg.

22. An apparatus as claimed in claim 21 wherein said wedge and peg protecting means is a shield plate.

23. An apparatus as claimed in claim 22 wherein said shield plate is shaped in a “U” configuration.

24. An apparatus for protecting tile seams, said tile seams being created between adjacently placed modular tiles, said apparatus comprising, in combination:
a tile seam protecting plate, said tile seam protecting plate placed to substantially cover said tile seams, said tile seam protecting plate attached with a plate attaching means.

25. An apparatus as claimed in claim 24 wherein said plate attaching means comprises the apparatus as claimed in claim 15
